(19) United States
(12) Patent Application Publication
(10) Pub. No.: US 2025/0198261 A1
(43) Pub. Date: Jun. 19, 2025

(54) SUBSEA TERMINATION ASSEMBLY

(71) Applicant: OneSubsea AS, Lysaker (NO)

(72) Inventors: Malik ABDUL, Richmond, TX (US); David HICKMAN, Mobile, AL (US); Kevin LERCH, Mobile, AL (US)

(21) Appl. No.: 18/851,241

(22) PCT Filed: Mar. 24, 2023
(86) PCT No.: PCT/EP2023/057619

§ 371 Date: Sep. 26, 2024

(30) Foreign Application Priority Data
Mar. 31, 2022 (NO) 20220395

(51) Int. Cl. E21B 43/01; E21B 41/10

(52) U.S. Cl. CPC E21B 43/0107; E21B 41/10

(57) ABSTRACT

A subsea termination assembly comprising a main body, a stab pin with a stabbing end for guiding of the subsea termination assembly during landing on a receiving subsea structure, and a hinge assembly connecting the stab pin to the main body. The subsea termination assembly comprises a connected portion that is pivotably attached to the main body with the hinge assembly. The stab pin comprises a free portion and the free portion comprises the stabbing end. The subsea termination assembly comprises a stab pin connection arrangement, detachably connecting the free portion to the connected portion. A method is also disclosed.

### PRIOR RELATED APPLICATIONS

The present application is a national entry of PCT Application No. PCT/EP2023/057619, filed on Mar. 24, 2023, which claims priority under the Paris Convention to Norwegian Application No. NO20220395, filed on March 31,2022. The entire contents of such prior applications are incorporated by reference herein.

### TECHNICAL FIELD

The present invention relates to a subsea termination assembly configured to land on a support at the seabed.

### BACKGROUND ART

When installing electric power cables, fluid lines, umbilicals, and the like on the seabed, it is common to provide them with a guiding means at their end to facilitate correct installation. A termination assembly will typically be provided at the end, and the guiding means can be attached to the termination assembly.

When landing some types of subsea equipment on the seabed, a pre-installed guidepost extends vertically upwards, and a receiving guide funnel arranged on the equipment receives the guidepost.

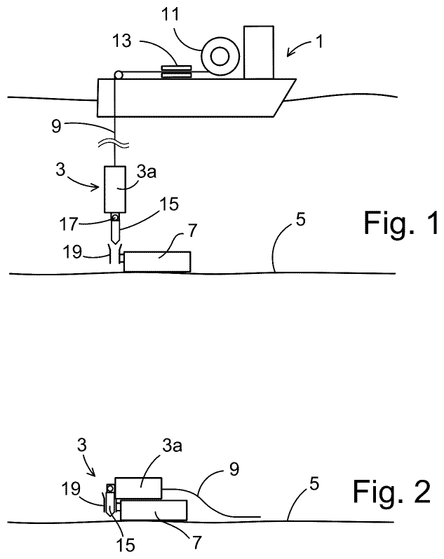

When installing subsea umbilicals, it is known to provide the umbilical termination assembly (UTA) with a downwardly extending stab pin, which is received by a guide funnel already installed at the seabed. Such a solution is shown in FIG. 1 and FIG. 2 of publication EP2172616. Once the stab pin has landed in the receiving funnel, the UTA is rotated from its initial vertical orientation, into its final horizontal orientation. This rotation is enabled by a hinge arrangement connecting the UTA and the stab pin.

Patent publication U.S. Pat. No. 5,320,175 discloses a solution for installation of a subsea jumper. At each end of the jumper, there is provided a downwardly extending stab. The stabs are inserted into two receiving stab receptacles. This provides correct location of the jumper ends. Moreover, the jumper ends are connected to the stabs with a hinge, such that after landing, the jumper ends can take a substantially horizontal orientation after having been lowered down with a vertical orientation.

Moreover, WO2010009510 discloses a tool and a method for installing free connector hubs of subsea flowlines to enable a clamping device to be fitted thereto.

When installing various types of cables, fluid lines, umbilicals, and the like on the seabed, it is common to use a laying vessel with a tensioner system. The tensioner system holds onto the cable (or the like) while paying it out into the sea in a controlled manner. Before such operation can start, the cable, umbilical or the like, must be installed in the tensioner system. In some cases, it also needs to be inserted through other types of equipment or parts of the surface vessel. In some situations, the stab pin may act as a snagging point and it may be cumbersome to install the cable or umbilical or the like with the tensioner system while the stab pin is connected to the termination assembly. This is alleviated by removing the stab pin and re-mounting it when the cable, umbilical or the like has been installed in the tensioner.

This process involves a significant use of time. Moreover, it involves safety risks, as the stab pin and the components attaching the stab pin to the termination assembly are heavy components.

An object of the present invention may be to reduce one or more of the said problems.

### SUMMARY OF INVENTION

According to a first aspect of the present invention, there is provided a subsea termination assembly comprising a main body, a stab pin with a stabbing end for guiding of the subsea termination assembly during landing on a receiving subsea structure, and a hinge assembly that connects the stab pin to the main body. The subsea termination assembly has a connected portion that is pivotably attached to the main body with the hinge assembly. The stab pin comprises a free portion and the free portion comprises the stabbing end. Moreover, the subsea termination assembly comprises a stab pin connection arrangement by means of which the free portion is detachably connected to the connected portion.

With such a subsea termination assembly, the stab pin, or alternatively a part of the stab pin, can easily be removed from the subsea termination assembly before going through the tensioner and when preparing the subsea termination assembly for being lowered towards the seabed. After such preparation, the stab pin can be re-installed to the subsea termination assembly before said lowering commences.

The stabbing end of the free portion is configured to be inserted into a guide funnel at the seabed.

In some embodiments, the connected portion or the free portion, respectively, comprises an insert section that is insertable into a bore of the free portion or the connected portion, respectively. Moreover, the stab pin connection arrangement can further comprise securing means, for instance securing bolts or pins, for securing the connected portion and the free portion when in the inserted state.

Advantageously, the subsea termination assembly can further comprise an angular pin alignment arrangement that is configured to angularly align the free portion to the connected portion. Typically, the angular pin alignment arrangement can comprise an alignment pin and a notch on the free portion and the connected portion, or vice versa, to facilitate correct attachment of the free portion to the connected portion.

In some embodiments, the hinge assembly can comprise a trunnion pin which is attached to the main body. Moreover, the stab pin and a yoke can be connected to the trunnion pin, such that both the yoke and the stab pin can pivot about the trunnion pin.

Advantageously, the yoke comprises a lifting eye configured for interfacing with a lifting means, such as a crane.

In some embodiments, a subsea umbilical can be connected to the subsea termination assembly. The subsea termination assembly will then be a subsea umbilical termination assembly (SUTA).

The free portion can in some embodiments comprise a landing plate. The landing plate is configured to halt the insertion of the stab pin into the guide funnel. This ensures correct vertical position of the pivot point during pivoting of the main body.

According to a second aspect of the invention, there is provided a method of installing a subsea termination assembly with a main body, at a subsea location. The method comprises the following steps:
a) at a floating structure, for instance a vessel, installing a utility string, which is connected to the main body, in a tensioning system;
b) attaching a free portion of the stab pin to a connected portion, wherein the connected portion is attached to the main body with a hinge assembly;
c) lowering the termination assembly from the floating structure towards the seabed;
d) at the seabed, inserting a stab pin, which is attached to the main body through the hinge assembly, into a guide funnel;
e) pivoting the main body with respect to the stab pin, thus landing the main body onto a receiving subsea structure.

With the term utility string is meant a string with a function other than or in addition to transferring mechanical forces, such as transfer of signals, electric power, or fluid, or a combination of such functions, such as an umbilical.

In some embodiments, the connected portion can be formed as a part of the stab pin. In other embodiments, the connected portion can be for instance an attachment means that does not constitute a part of the stab pin and that is configured for attachment of the free portion of the stab pin to the hinge assembly.

In some embodiments, step b) can comprise inserting an insert section of the connected portion or the free portion, respectively, into a bore of the free portion or the connected portion, respectively, and then securing the free portion to the connected portion with a securing means.

In some embodiments, the utility string can be a subsea umbilical.

Moreover, in some embodiments, step c) may comprise suspending the subsea termination assembly through a yoke with a lifting eye, wherein the yoke is configured to pivot, with respect to the main body, about the same pivot axis as the stab pin.

With the term subsea umbilical is meant a string comprising at least two of the following types of transmission: electric power transmission, fluid transmission, optical signal transmission, and electric signal transmission. With the term electric power transmission is meant transmission of electric power of more than 10 KW. Thus, for instance, a subsea umbilical according to the meaning herein can comprise power cores for transferring electric power of more than 10 KW, and further comprise a fluid tube, such as for transmission of chemicals (e.g. MEG) or hydraulic pressure.

According to a third aspect of the present invention, there is provided a subsea termination assembly comprising a main body, a stab pin with a stabbing end for guiding of the subsea termination assembly during landing on a receiving subsea structure, and a hinge assembly connecting the stab pin to the main body in a pivotable manner. The subsea termination assembly further comprises a yoke with a lifting eye. According to the third aspect of the invention, the hinge assembly comprises a trunnion pin which is attached to the main body. The stab pin and the yoke are connected to the trunnion pin, such that the yoke and the stab pin can pivot about the trunnion pin. In this manner, the yoke and the stab can both pivot with respect to the main body, about a common pivot axis.

A subsea termination assembly of the type presented herein can be connected to both end of a utility string, such as an umbilical, power cable or the like.

### DETAILED DESCRIPTION OF THE INVENTION

While various features of the invention have been discussed in general terms above, a more detailed and non-limiting example of embodiment will be presented in the following with reference to the drawings, in which

FIG. 1 is a schematic view of a floating vessel lowering a subsea umbilical termination assembly (SUTA) towards the seabed;

FIG. 2 is a schematic view illustrating the SUTA having landed on a receiving frame at the seabed;

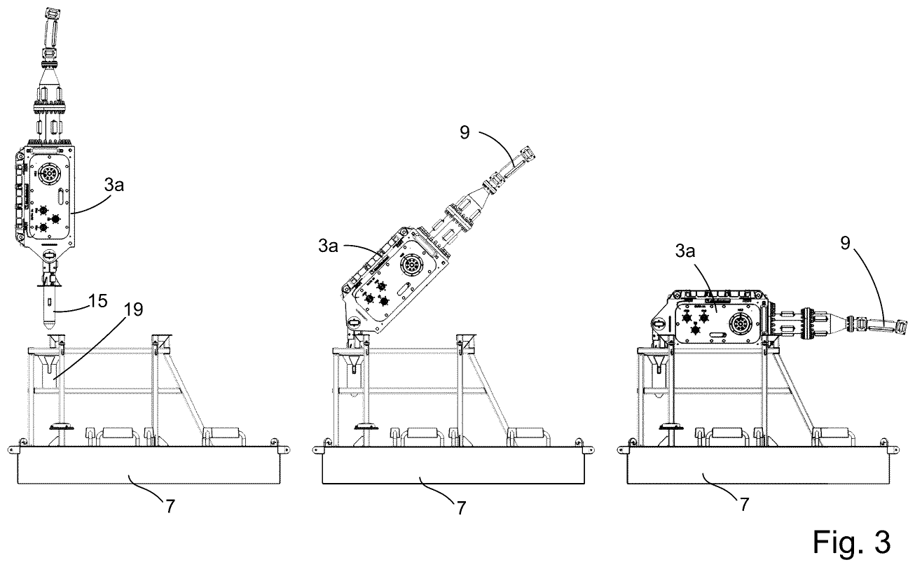

FIG. 3 is a more realistic illustration of the SUTA pivoting in a guided manner, to land on the receiving frame;

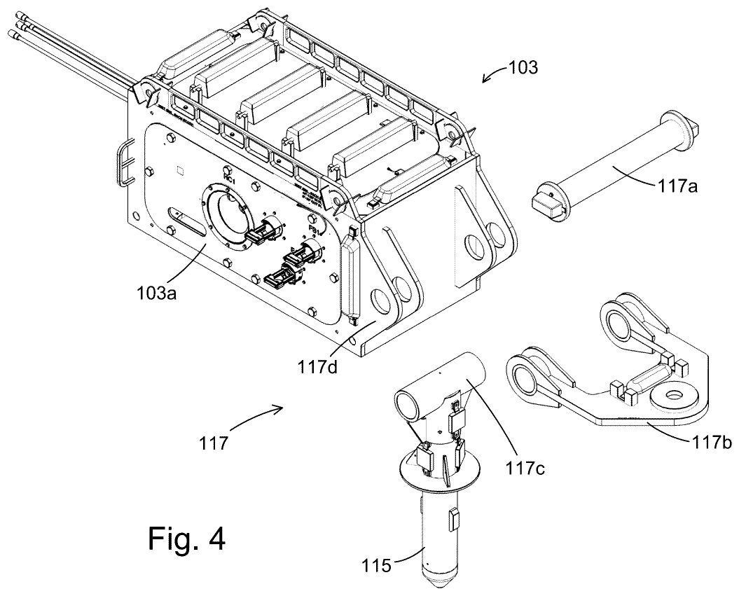

FIG. 4 is a perspective view of a SUTA, having a detachable stab pin, however not according to the present invention;

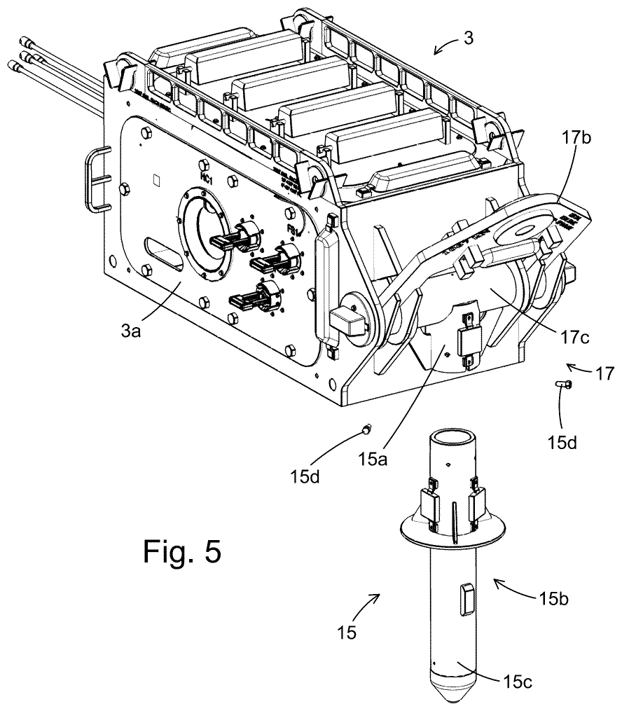

FIG. 5 is a perspective view of a SUTA according to the present invention, also having a detachable stab pin;

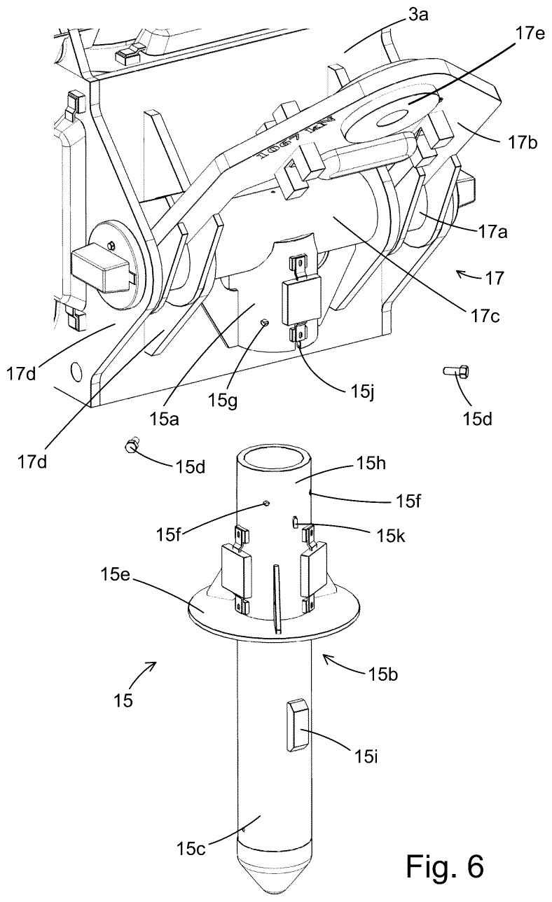

FIG. 6 is an enlarged view of a portion of FIG. 5; and

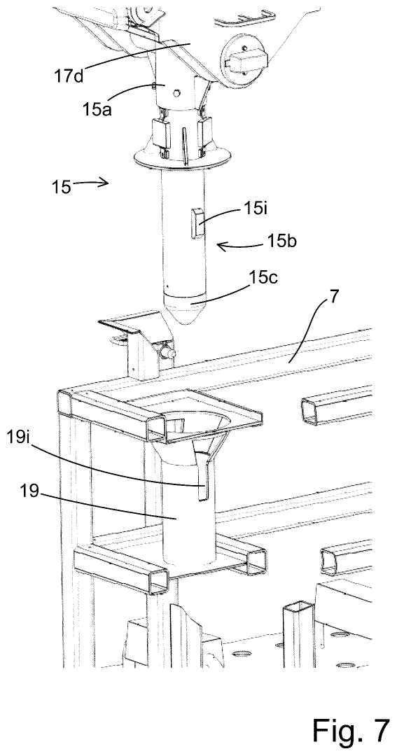

FIG. 7 is a perspective view of a detachable stab pin immediately before being stabbed into a receiving guide funnel subsea.

FIG. 1 depicts a floating structure 1, such as a vessel, which is about to land a subsea umbilical termination assembly (SUTA) 3 at the seabed 5. At the seabed 5, there is already installed a receiving structure 7, which is configured to receive the SUTA 3. The SUTA 3 is arranged at one end of an umbilical 9. The umbilical 9 can typically be reeled off from a bobbin 11 on the floating structure 1, through a tensioner 13 which is used to control the release of the umbilical 9 into the sea.

To the lower end of the SUTA 3, there is arranged a stab pin 15. The stab pin 15 is connected to a main body 3a of the SUTA 3 through a hinge assembly 17. Thus, the stab pin 15 can pivot with respect to the main body 3a.

The stab pin 15 is configured to enter a guide funnel 19 that is attached to the receiving structure 7. Thus, when landing the SUTA 3, the stab pin 15 is guided into the guide funnel 19, typically with the aid of an ROV (not shown). When the stab pin 15 has landed inside the guide funnel 19, the main body 3a pivots with respect to the stab pin 15, and lands in a guided manner on the receiving structure 7.

FIG. 3 depicts three images of a more realistic embodiment of the SUTA 3. The three images show, from the left towards the right,
a situation immediately before the stab pin 15 enters the guide funnel 19;
a situation wherein the stab pin 15 has fully entered the guide funnel 19 and the main body 3a has started to pivot towards the receiving structure 7; and
a situation wherein the main body 3a has landed fully on the receiving structure 7.

To prepare the lowering of the SUTA 3 (cf. FIG. 1) from the floating structure 1, the umbilical 9 must be installed in the tensioner 13. This is a cumbersome process if performed while the stab pin 15, which may represent a snagging point, is still attached to the main body 3a of the SUTA 3. Consequently, it is common to temporarily remove the stab pin 15 during such preparation.

FIG. 4 depicts a SUTA 103 of an embodiment which is not according to the present invention. To remove the stab pin 115 from the main body 103a, the operator needs to pull out a trunnion pin 117a from its interface (in apertures of hinge brackets 117d) with main body 103a. Also connected to the trunnion pin 117a, when in the assembled state, is a yoke 117b. To the stab pin 115 there is connected a trunnion-receiving sleeve 117c. When in the assembled state, the trunnion pin 117a extends through the trunnion-receiving sleeve 117c. The components of this hinge assembly 117 are large and heavy and require considerable time and heavy equipment for disassembly and later re-assembly.

An improved solution is shown in FIG. 5, which depicts a solution according to the present invention. The stab pin 15 comprises a connected portion 15a, which is attached to the hinge assembly 17. The stab pin 15 further comprises a free portion 15b. The free portion 15b has a stabbing end 15c, configured to be inserted into the guide funnel 19 (cf. FIG. 1 to FIG. 3). The free portion 15b is detachable from the connected portion 15a.

The free portion 15b can be maintained in an attached state, where it is attached to the connected portion 15a, by means of a set of securing bolts 15d.

Reference is also made to FIG. 6, which depicts an enlarged portion of FIG. 5. The free portion 15b of the stab pin 15 has a landing plate 15e, configured to abut against an upper portion of the guide funnel 19 when fully inserted.

The part of the free portion 15b that is opposite the stabbing end 15c comprises an insert section 15h that can be inserted into a bore of the connected portion 15a of the stab pin 15. When in the inserted state, it is secured by means of the securing bolts 15d. The securing bolts 15d are inserted through first securing apertures 15f in the free portion 15b, which are aligned with second securing apertures 15g in the connected portion 15a. In other embodiments, a section of the connected portion 15a could be insertable into a part of the free portion 15b.

Hinge brackets 17d, which are attached to the main body 3a, comprise apertures through which the trunnion pin 17a extends. The yoke 17b and the stab pin 15, i.e. the connected portion 15a, connect to and pivot about the trunnion pin 17a.

The yoke 17b is typically used as a lifting interface when maneuvering the SUTA 3 on the surface structure 1. The yoke 17b has a lifting eye 17e, where a lifting means can connect.

In the embodiment shown in FIG. 6, the connected portion 15a, which is configured to receive the insert section 15h, comprises an alignment notch 15j at its lower edge. The alignment notch 15j is configured to receive an alignment protrusion 15k that is arranged on the insert section 15h. This ensures correct angular alignment between the free portion 17b and the connected portion 15a. The alignment notch 15j and the alignment protrusion 15k constitute an angular pin alignment arrangement.

Reference is now made to FIG. 7, which shows the situation corresponding to the one shown in FIG. 1. The free portion 15b of the stab pin 15 comprises guide means 15i configured to rotationally align the stab pin 15 with engaging funnel guide means 19a in the guide funnel 19. The guide means 15i is, in the shown embodiment, located between the landing plate 15e and the stabbing end 15c.

1. A subsea termination assembly comprising
a main body,
a stab pin with a stabbing end for guiding of the subsea termination assembly during landing on a receiving subsea structure, and
a hinge assembly connecting the stab pin to the main body,
characterized in that
the subsea termination assembly comprises a connected portion that is pivotably attached to the main body with the hinge assembly,
the stab pin comprises a free portion,
the free portion comprises the stabbing end,
the subsea termination assembly comprises a stab pin connection arrangement detachably connecting the free portion to the connected portion.

2. The subsea termination assembly according to claim 1, characterized in that the connected portion or the free portion, respectively, comprises an insert section that is insertable into a bore of the free portion or the connected portion, respectively, and that it further comprises securing means for securing the connected portion and the free portion when in the inserted state.

3. A The subsea termination assembly according to claim 1, characterized in that the hinge assembly comprises a trunnion pin which is attached to the main body, and that the stab pin and a yoke are connected to the trunnion pin, such that the yoke and the stab pin can pivot about the trunnion pin.

4. The subsea termination assembly according to claim 3, characterized in that the yoke comprises a lifting eye configured for interfacing with a lifting means.

5. The subsea termination assembly according to claim 1, characterized in that an umbilical is connected to the subsea termination assembly.

6. The subsea termination assembly according to claim 1, characterized in that it further comprises an angular pin alignment arrangement configured to angularly align the free portion to the connected portion.

7. A method of installing a subsea termination assembly, having a main body, at a subsea location, comprising the following steps:
a) at a floating structure, installing a utility string, which is connected to the main body, in a tensioning system;
c) lowering the termination assembly from the floating structure towards the seabed;
d) at the seabed, inserting a stab pin, which is attached to the main body through a hinge assembly, into a guide funnel;
e) pivoting the main body with respect to the stab pin, thus landing the main body onto a receiving subsea structure;
characterized in that the method further comprises, between steps a) and c):
b) attaching a free portion of the stab pin to a connected portion, wherein the connected portion is attached to the main body with the hinge assembly.

8. The method according to claim 7, characterized in that step b) comprises inserting an insert section of the connected portion or the free portion, respectively, into a bore of the free portion or the connected portion, respectively, and then securing the free portion to the connected portion with a securing means.

9. The method according to claim 7, characterized in that the utility string is a subsea umbilical.

10. The method according to claim 7, characterized in that step c) comprises suspending the subsea termination assembly through a yoke with a lifting eye, wherein the yoke is configured to pivot, with respect to the main body, about the same pivot axis as the stab pin.

11. A subsea termination assembly comprising
a main body,
a stab pin with a stabbing end for guiding of the subsea termination assembly during landing on a receiving subsea structure, and
a hinge assembly connecting the stab pin to the main body in a pivotable manner,
a yoke with a lifting eye;
characterized in that the hinge assembly comprises a trunnion pin which is attached to the main body, and that the stab pin and the yoke are connected to the trunnion pin, such that the yoke and the stab pin can pivot about the trunnion pin.
